(19) United States
(12) Patent Application Publication
(10) Pub. No.: US 2026/0094893 A1
(43) Pub. Date: Apr. 2, 2026

(54) MODULAR BATTERY THERMAL AND PRESSURE MANAGEMENT SYSTEM

(71) Applicant: Brelle & Co, Inc., Signal Hill, CA (US)

(72) Inventors: Martin HERMEZ, Signal Hill, CA (US); Alejandro Arias FELIPE, Huntington Beach, CA (US); Fatemeh AFZALI, Long Beach, CA (US); Aratz PINTER, Long Beach, CA (US); Valentina CALAZA, Signal Hill, CA (US); Niharika SASHIDHAR, Signal Hill, CA (US)

(21) Appl. No.: 19/346,203

(22) Filed: Sep. 30, 2025

Related U.S. Application Data
(60) Provisional application No. 63/701,416, filed on Sep. 30, 2024.

(51) Int. Cl. H01M 10/6552; H01M 10/052; H01M 10/613; H01M 10/6557; H01M 10/6568; H01M 50/204; H01M 50/258; H01M 50/262; H01M 50/502; H01M 50/618; H01M 50/673

(52) U.S. Cl. CPC H01M 10/6552; H01M 10/052; H01M 10/613; H01M 10/6557; H01M 10/6568; H01M 50/204; H01M 50/258; H01M 50/262; H01M 50/502; H01M 50/618; H01M 50/673

(57) ABSTRACT

The present embodiments provide a battery cooling system with a configurable number of frames disposed between end plates that allows a coolant to flow between the battery cooling system to control a temperature of battery cells disposed in the battery cooling system. The end plates disposed on opposing ends of the system can include manifolds that allow the coolant to move through the end plates. Further, each frame can include a number of subframes to retain battery cells and allow the coolant to flow adjacent to the battery cells. A wet bus can be disposed in the frame and a dry bus disposed on an exterior of the frame can electrically connect the battery cells to exterior circuitry.

### CROSS-REFERENCE TO RELATED APPLICATION(S)

The present application claims priority to U.S. Provisional Patent Application No. 63/701,416, titled “MODULAR BATTERY THERMAL AND PRESSURE MANAGEMENT SYSTEM,” and filed on Sep. 30, 2024, the entirety of which is incorporated by reference herein.

### TECHNICAL FIELD

The present application generally relates to systems and methods for moderating thermal and pressure conditions in modular battery packs with a liquid coolant.

### BACKGROUND

Battery systems comprise multiple cells arranged in close proximity to harness their collective power output while minimizing their footprint. Battery systems may be cooled to improve the safety, performance, and lifespan of the battery systems by preventing overheating. Various cooling techniques may include inter-cell foam systems, end-of-module foam, springs, flat coil bands, inter-cell heat sinks, cold plates, edge-cell cold plates, tab cooling, immersion cooling systems, etc.

Many battery system designs may face significant challenges that may include overheating when cells are closely aligned, fragility that may require special handling and packaging to protect inner components from external forces and punctures, and an inability to achieve an optimized system that combines modularization, effective cooling, and robust structural integrity in a single package.

### SUMMARY

This summary is provided to introduce a selection of concepts in a simplified form that are further described below in the detailed description. This summary is not intended to identify essential features of the claimed subject matter, nor is it intended to be used as an aid in determining the scope of the claimed subject matter.

The present embodiments provide a battery cooling system with a configurable number of frames disposed between end plates that allows a coolant to flow between the battery cooling system to control a temperature of battery cells disposed in the battery cooling system. The end plates disposed on opposing ends of the system can include manifolds that allow the coolant to move through the end plates. Further, each frame can include a number of subframes to retain battery cells and allow the coolant to flow adjacent to the battery cells. A wet bus can be disposed in the frame and a dry bus disposed on an exterior of the frame can electrically connect the battery cells to exterior circuitry.

In a first example embodiment, a battery cooling system is provided. The battery cooling system can include a first end plate. The first end plate can include a first inlet port for receiving a liquid coolant, a first outlet port, and at least a first manifold channel formed in the first end plate. The first manifold channel can be configured to carry the liquid coolant along the first end plate between the first inlet port and the first outlet port.

The battery cooling system can also include a first frame disposed adjacent to the first end plate. The first frame can include an outer subframe and a first inner subframe disposed within the outer subframe. The first inner subframe can be configured to be disposed at a first side of a first battery cell and a second battery cell. The first frame can also include a second inner subframe disposed at a second side of the first battery cell. The first inner subframe and the second inner subframe can secure the first battery cell. The first frame can also include a third inner subframe disposed at a second side of the second battery cell. The first inner subframe and the third inner subframe can secure the second battery cell. The first frame can also include a wet bus disposed in an interior of the outer subframe and configured to be electrically connected to any of the first battery cell and the second battery cell. The first frame can also include a dry bus disposed on an exterior of the outer subframe and electrically connected to the wet bus.

The battery cooling system can also include a second end plate disposed adjacent to the first frame at an opposite side as the first end plate. The second end plate can include a second inlet port, a second outlet port, and at least a second manifold channel formed in the second end plate and configured to carry the liquid coolant between the second inlet port and the second outlet port along the second end plate.

In some instances, the first inner subframe, the second inner subframe, and the third inner subframe are encapsulated by the outer subframe.

In some instances, the battery cooling system can further include a set of fasteners disposed between the first end plate, the first frame, and the second end plate to secure the first end plate to the second end plate.

In some instances, the second inner subframe comprises a recess configured to clamp an excess portion of the first battery cell extending from the first battery cell.

In some instances, the outer subframe further comprises a number of channels disposed on at least one side of the outer subframe and connected to any of the first manifold channel and the second manifold channel, wherein the number of channels are configured to control a flow of the liquid coolant through the number of channels.

In some instances, a choke is disposed between any of the number of channels in the outer subframe, wherein the choke is configured to increase or reduce the flow the liquid coolant through the number of channels based on temperature of the liquid coolant.

In some instances, the battery cooling system can further include a second frame disposed between the first frame and the second end plate, wherein the second frame is configured to retain a third battery cell and a fourth battery cell.

In some instances, the first battery cell, the second battery cell, the third battery cell, and the fourth battery cell include any of a Lithium-ion battery cell, a Lithium-Iron-Polonium battery cell, a Lithium-Silicon battery, a Lithium-Metal battery, and a Solid-State battery.

In some instances, the battery cooling system can further include a pump and a reservoir connected to any of the first manifold channel or the second manifold channel to regulate a pressure of the liquid coolant disposed in the battery cooling system.

In some instances, the pump maintains the liquid coolant at a pressure between 1 bar and 10 bars.

In some instances, the first end plate, the first frame, and the second end plate form a load bearing structural unit when secured together.

In some instances, the battery cooling system can further include a first liquid seal disposed between the first end plate and the second inner subframe of the first frame, and a second liquid seal disposed between the second end plate and the third inner subframe of the first frame.

In another example embodiment, a method for manufacturing a battery cooling system is provided. The method can include providing a first end plate. The first end plate can include a first inlet port, a first outlet port, and at least a first manifold channel formed in the first end plate;

The method can also include disposing a first frame adjacent to the first end plate. The first frame can include an outer subframe and a number of inner subframes encapsulated within the outer subframe and configured to retain at least a first battery cell and a second battery cell. The first frame can also include a wet bus disposed in an interior of the outer subframe and configured to be electrically connected to any of the first battery cell and the second battery cell. The first frame can also include a dry bus disposed on an exterior of the outer subframe and electrically connected to the wet bus.

The method can also include disposing a second end plate adjacent to the first frame at an opposite side as the first end plate. The second end plate can include a second inlet port, a second outlet port, and at least a second manifold channel formed in the second end plate.

In some instances, the number of inner subframes includes a first inner subframe disposed within the outer subframe, wherein the first inner subframe is configured to be disposed at a first side of the first battery cell and the second battery cell. The number of inner subframes can also include a second inner subframe disposed at a second side of the first battery cell, wherein the first inner subframe and the second inner subframe secure the first battery cell. The number of inner subframes can also include a third inner subframe disposed at a second side of the second battery cell, wherein the first inner subframe and the third inner subframe secure the second battery cell.

In some instances, the method can also include receiving a coolant at any of the first inlet port and the second inlet port, wherein the coolant is configured to traverse from the first inlet port and/or the second inlet port to the first outlet port and/or the second outlet port via the first manifold channel and/or the second manifold channel.

In some instances, the method can also include securing a set of fasteners between the first end plate, the first frame, and the second end plate to secure the first end plate to the second end plate.

In some instances, the method can also include disposing a choke between any of a number of channels formed in the outer subframe, wherein the choke is configured to increase or reduce a flow of the coolant through the number of channels based on temperature of the coolant.

In some instances, the method can also include disposing a second frame between the first frame and the second end plate, wherein the second frame is configured to retain a third battery cell and a fourth battery cell.

In some instances, the method can also include connecting a pump and a reservoir to any of the first manifold channel or the second manifold channel to regulate a pressure of the coolant disposed in the battery cooling system.

In some instances, the method can also include disposing a first liquid seal between the first end plate and the second inner subframe of the first frame, and disposing a second liquid seal between the second end plate and the third inner subframe of the first frame.

The foregoing general description of the illustrative embodiments and the following detailed description thereof are merely exemplary aspects of the teachings of this disclosure and are not restrictive.

### BRIEF DESCRIPTION OF THE DRAWINGS

For a better understanding of the embodiments described in this application, reference should be made to the Detailed Description below, in conjunction with the following drawings in which reference numerals refer to corresponding parts throughout the figures.

FIG. 1 is a diagram of an example battery cooling system, according to some embodiments.

FIG. 2 is a first exploded view of an example battery cooling system, according to some embodiments.

FIG. 3 is a second exploded view of the example battery cooling system, according to some embodiments.

FIG. 4 is a diagram of an example frame, according to some embodiments.

FIG. 5 is an exploded view of an example frame, according to some embodiments.

FIG. 6 is a diagram of a top-down view of an example battery cooling system with two cells within a frame, according to some embodiments.

FIG. 7 is a diagram of example end plates, according to some embodiments.

FIG. 8 is a diagram of example coolant flow through the battery cooling system, according to some embodiments.

FIGS. 9A and 9B illustrate views of example choke features, according to some embodiments.

FIG. 10 is an example diagram of coolant flow through the system, according to some embodiments.

FIG. 11 illustrates an example outer subframe, according to some embodiments.

FIG. 12 illustrates example frames as part of a battery cooling system, according to some embodiments.

FIG. 13 illustrates an example exploded view of the battery cooling system, according to some embodiments.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. It will be apparent to one of ordinary skill in the art that the subject matter may be practiced without these specific details. Moreover, the particular embodiments described herein are provided by way of example and should not be used to limit the scope of the disclosures to these particular embodiments.

### Overview

Battery systems are made of a collection of cells. Each of these cells may produce power and heat, which will be impacted by their own heat which adversely affects power output. Additionally, battery cells are typically fragile, weight intolerant, and should be protected with an overall system such as an electric vehicle in order to ensure safety operation.

Systems and methods here may be used to both cool or thermally regulate the battery cells, and thereby increase their power output and efficiency, to provide a rigid structure which may be used with the overall system as load bearing or ruggedized and thereby protected and keep the cells under precise pressure conditions. Additionally, the systems and methods here provide stacked or modular cell design that may be added to, scaled, or otherwise customized to whichever engineering design is desired in the overall system. Such a modular, load bearing, thermally and pressure-controlled systems may have many advantages over old systems that had to be fit specific, fragile and overheated.

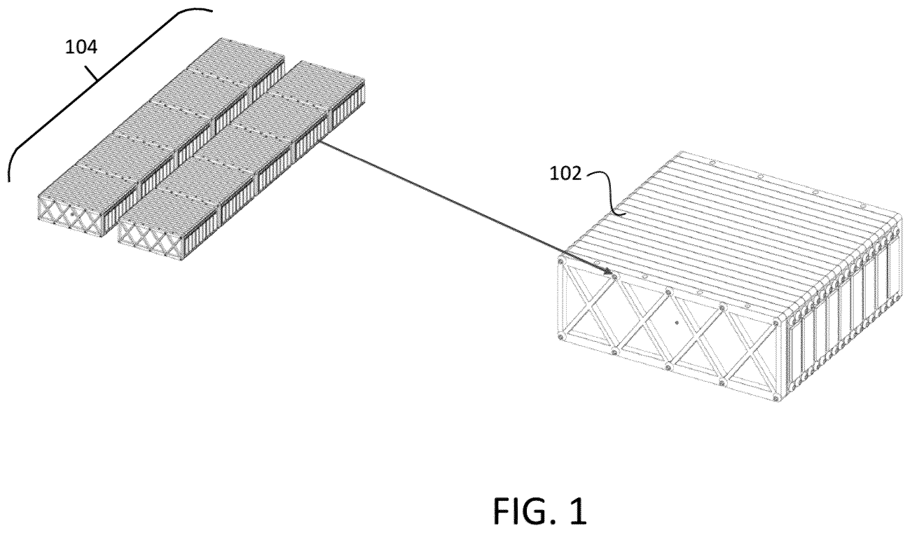

FIG. 1 illustrates an overview of an example stack modules including multiple battery cells 102. FIG. 1 illustrates how multiple numbers of such stacks may be arranged together as a stacked unit 104. Such a stack and rigid unit may be able to closely align battery cells, provide a rigid structure, and maintain high power output with the cooling systems described herein. The modular battery thermal management system architecture may accommodate any predetermined number of electrochemical cells within individual modular units and any predetermined number of modular units within the overall system assembly without limitation. The scalable system design may incorporate multiple battery thermal management assemblies to meet specific application and performance specifications.

The battery cells may function as independent electrical and mechanical units, where each of the battery cells 102 may operate autonomously or may be operatively interconnected with adjacent modules to form integrated super-module configurations or fully load bearing capable structures, for example in an electric vehicle applications, the battery cell assemblies may comprise structural components of the vehicle chassis framework, thereby contributing to the overall structural integrity and load-bearing capacity of the system rather than imposing additional weight burden or using supplementary structural support mechanisms from the host system.

The structural configurations and thermal management systems described herein may provide thermal regulation and heat dissipation capabilities for the battery assemblies while achieving enhanced volumetric energy density characteristics. The integrated thermal management approach may enable better battery performance while maximizing the energy storage capacity per unit volume and per unit mass of the overall system.

Such a modular and load bearing system may be conducive to moving batteries into fully structuralized assemblies that may serve dual functions as both energy storage devices and primary structural elements. The system architecture may use a stacked or sandwich assembly configuration wherein multiple modular components are mechanically integrated to form rigid, high-stiffness structural assemblies when fully assembled and secured together through the fastening mechanisms described herein.

In some examples, a battery system may have higher voltage than desired for maintenance constraints, so the modular format may provide the flexibility to segment the overall system into smaller, more manageable electrical units. In such configurations, each battery cell 102 may be designed to maintain electrical potential below predetermined safety limits, such as 60 volts, thereby facilitating safer maintenance procedures and compliance with electrical safety protocols.

The modular system architecture may be chemistry-agnostic and format-independent, thereby enabling compatibility with a wide range of battery cell technologies and electrochemical compositions. The versatile design approach allows for the accommodation of various battery chemistries, cell formats, and electrical configurations while utilizing a minimal number of standardized components, thereby providing manufacturing efficiency and design flexibility within the systems and methods described herein.

### Battery Cooling System Arrangement Examples

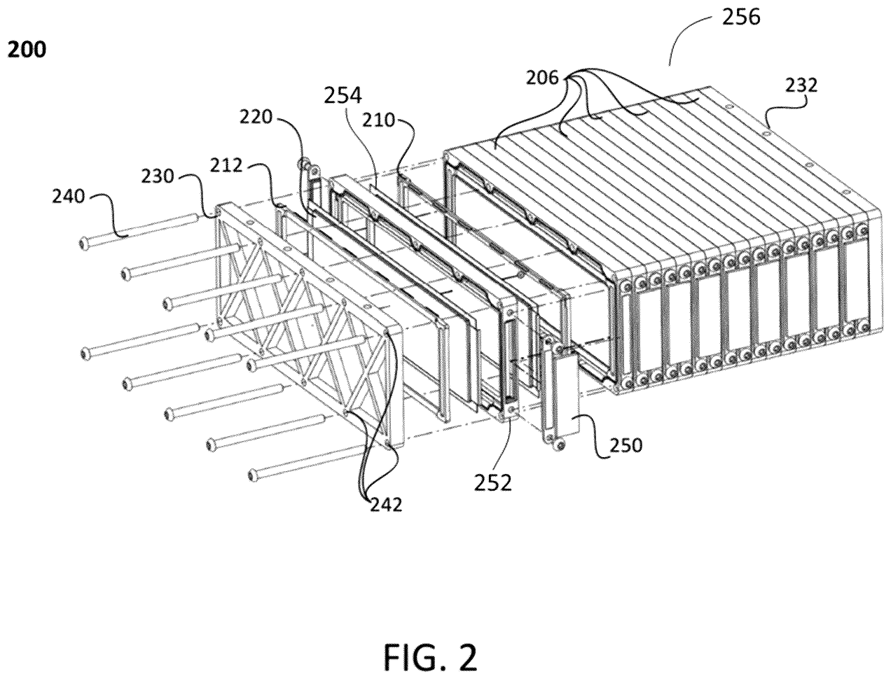

FIG. 2 illustrates an exploded view 200 of a stacked unit 256 with multiple frames 206. The stacked unit 256 may include a plurality of individual frames 206 (or “modules”) placed next to one another with a front plate 230 and an end plate 232 placed on ends of the stacked unit 256.

FIG. 2 further illustrates component parts within each frame 206 that may include a front plate 230 (or “first end plate”) and a second end plate 260. An outer subframe 252 can encapsulate a number of inner subframes (e.g., 212, 220, 210) and battery cells (e.g., 220, 254).

In the example of FIG. 2, the assembly can be secured with screws 240 which fit through holes 242 on front plate 230 through the outer subframe (or “outer carrier plate”) 252 and reach to the end plate 232 to thereby secure the sandwiched stacked unit 256 together with the end plate 232 having threads that match the screws 240.

In some examples, alternative mechanical fastening and securing systems may be employed to provide structural integration of the modular battery system. Such alternative mechanical securing mechanisms may include, but are not limited to, snap-fit engagement systems including resilient tabs and corresponding receptacles configured to provide reversible mechanical interlocking, latch-based fastening assemblies incorporating spring-loaded or cam-actuated retention mechanisms, bayonet-style coupling systems featuring rotational engagement interfaces, quick-release fastening mechanisms utilizing lever-actuated clamping forces, compression-fit assemblies employing interference-fit tolerances between mating components, magnetic retention systems incorporating permanent magnets or electromagnetically controlled holding forces, wedge-lock mechanisms providing mechanical advantage through inclined plane interfaces, toggle clamp assemblies offering rapid engagement and disengagement capabilities, or other mechanical fastening methodologies for maintaining structural integrity and sealing of the modular battery thermal management system while facilitating assembly, disassembly, and maintenance operations.

As illustrated in FIG. 2, the electrical connection 250 to stacked unit 256 may be on the side of the unit. This electrical connection 250 may provide the primary power transmission interface configured to conduct electrical energy generated by the internal battery cells from within the sealed modular assembly to external electrical systems and loads, including but not limited to vehicular propulsion systems, auxiliary power systems, energy storage networks, or other electrical infrastructure requiring battery power input.

In alternative examples, the positioning and orientation of the electrical connection interfaces may vary according to specific application requirements and system integration constraints. Such alternative electrical connection configurations may include mounting the electrical connection assemblies on the superior surface (top) of the modular unit to facilitate overhead cable routing and connection accessibility, positioning the electrical connections on the opposite lateral surface to accommodate different packaging constraints or cable management requirements, locating the electrical interfaces on the inferior surface (bottom) of the unit for under-floor or chassis-integrated wiring configurations, or incorporating multiple electrical connection points distributed across various surfaces of the modular assembly to provide redundant power extraction pathways or to support different electrical circuit configurations. The lateral mounting configuration depicted in FIG. 2 may illustrate one example of the electrical interface positioning within the modular battery thermal management system.

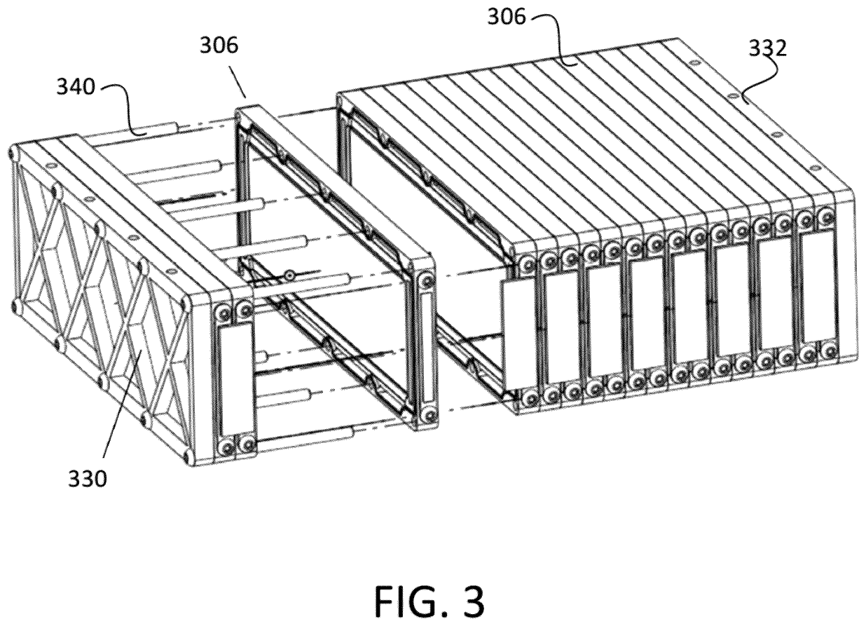

FIG. 3 illustrates a partially exploded view of a number of frames 306 arranged in conjunction with the front plate 330 and the end plate 332. The front plate 330 and the end plate 332 may be mechanically secured together through the utilization of screws 340. Each of the plurality of frames 306 may accommodate two battery cells in accordance with the structural arrangements and operational parameters as described herein.

As shown in FIG. 3, each of the plurality of frames 306 may be removable, thereby enabling selective removal, replacement, addition, or substitution within the overall system structure. This modular design architecture may provide enhanced flexibility for customization of both the structural configuration and the electrical power output characteristics of the battery system. Each of the frames as illustrated in FIG. 3 may be constructed in a sandwich or stacked assembly arrangement achieved through the repetition of any of the plurality of frames 306 with a front plate 330 and an end plate 332 placed at each terminal end.

The front plate 330 and the end plate 332 are configured to form the respective terminal ends of stacked unit via fasteners 340. These end plates may function as mechanical fasteners keeping any of the plurality of frames 306 tightly in contact to ensure proper sealing while simultaneously providing a path for the cooling liquid to enter and exit the stacked unit structures in accordance with the thermal management system as described herein.

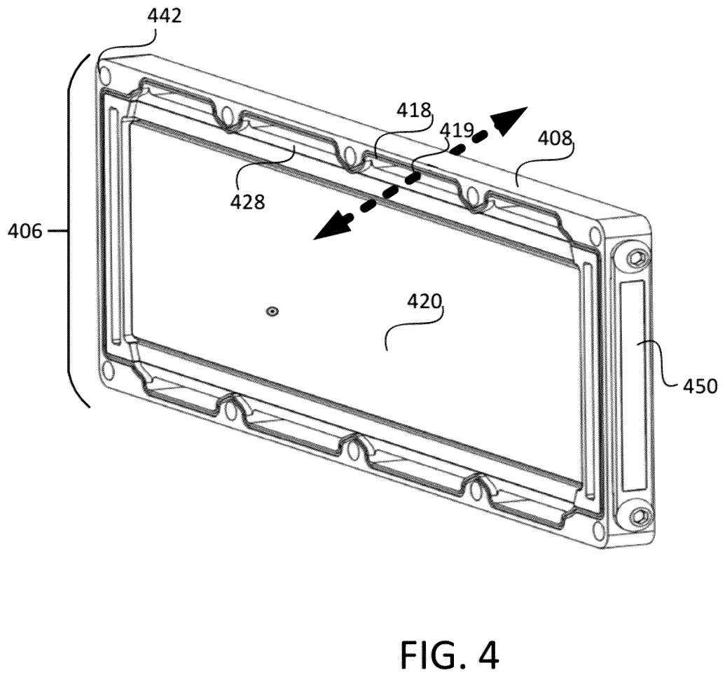

FIG. 4 illustrates a detailed view of an individual frame. The frame as described in FIG. 4 may be stacked against any number of other frames or end plates as described herein. Frame 406 may include one or more battery cell 420. Battery cell 420 may be of different chemistries like a lithium-ion battery cell, a lithium-iron-polonium battery cell, a lithium-silicon battery, a lithium-metal battery, a solid-state battery or any other type of electrochemical cell that may be manufactured in a pouch cell format or other suitable battery cell configurations.

Frame 406 can include an outer subframe that can surround the periphery of the inner carrier plates and battery cells thereby providing structural containment for the internal components. The outer subframe 408 can provide mechanical mating features and alignment structures to maintain the inner subframes and battery cells in predetermined positions within the assembly. The outer subframe 408 further can serve as a pressure vessel, providing a sealing surface configured to interface with adjacent carrier plates and surrounding structural elements to maintain system pressure integrity. Outer subframe 408 can further include a outer busbar 450 thereby providing an electrical conduction pathway configured to allow electrical current to exit the module assembly while simultaneously maintaining coolant containment within the sealed assembly environment.

The outer subframe 408 may additionally include one or more coolant manifold channel 419 to facilitate liquid coolant to flow between adjacent carrier plates. Each outer subframe 408 may incorporate any number of coolant manifold channels 419, with the quantity and configuration determined by the coolant flow characteristics and thermal management of the system. The geometric configuration of each coolant manifold channel 419 may be designed such that an adequate pressure differential is maintained across the channel while simultaneously providing sufficient coolant flow rate to achieve desired thermal management performance. On a first side of the outer subframe 408, fresh coolant at a lower temperature may be introduced into the system, while the opposite side is configured to collect the warmed coolant after it has absorbed and removed thermal energy from the battery cells.

Sealing systems may be positioned between adjacent outer subframe 408. The sealing system may include sealing elements such as an O-ring (not shown) and groove 418 that is designed to accommodate an O-ring or gasket element to seat against the outer subframe 408 and subsequently form a fluid-tight seal against adjacent carrier plates. The groove 418 may follow the contour of the outer subframe 408 while being routed around the tension rod guides 442 and other structural elements that provide mounting locations for the fastening mechanisms configured to secure the modular system components together in the assembled configuration.

Inner subframe 428 may be configured with mechanical mounting features and structural support for the battery cell 420. In combination with additional inner carrier plates within the system, the inner subframe 428 may maintain the battery cells within the interior space defined by the outer subframe 408, while allowing the battery cells to undergo thermal expansion in the intra-module direction during operation. The inner subframe 428 additionally serves to mechanically secure and position the outer busbar 450 within the module assembly.

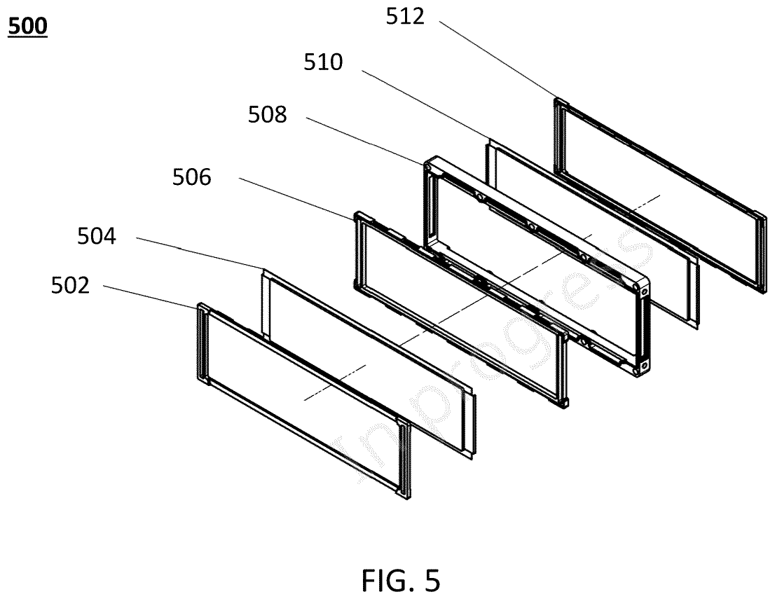

FIG. 5 illustrates an exploded view of an example frame (or “module”). The frame 500 as shown in FIG. 5 can include a number of subframes that can connect to and secure a number of battery cells as described herein. For instance, a first battery cell 504 can be disposed between a first inner subframe 506 and a second inner subframe 502, and a second battery cell 510 can be disposed between the first inner subframe 506 and a third inner subframe 512. The outer subframe 508 can be larger than inner subframes 502, 506, 512 such that the inner subframes 502, 506, 512 and battery cells 504, 510 are encapsulated within the outer subframe 508.

The frame as shown in FIG. 5, for example, can be part of a modular battery cooling configuration. For instance, frame 500 can be disposed between end plates and any number of intervening frames.

Further, frame 500 can improve thermal contact between the battery cells and the cooling system while maintaining structural integrity throughout the assembly. The configuration may allow for uniform pressure distribution across both battery cells within the module, thereby enhancing electrochemical performance and operational efficiency. In some aspects, the dual-cell arrangement within a single module may provide increased energy density while maintaining manageable thermal and electrical characteristics for the overall system.

The subframes of the frame may be manufactured with various materials including metals such as aluminum, steel, titanium, or magnesium alloys, thermoplastics such as polyethylene, polypropylene or polycarbonate, polymers including epoxy resins, polyurethane, or polyamide, and composite materials such as carbon fiber reinforced plastics, glass fiber composites, or hybrid fiber composites. These components may be produced using different manufacturing methodologies including casting processes such as sand casting or investment casting, pressure casting techniques, die casting for high-volume production, injection molding for thermoplastic components, additive manufacturing processes such as 3D printing including selective laser sintering or fused deposition modeling, computer numerical control (CNC) machining for precision components, vacuum infusion for composite materials, wet layup processes for fiber-reinforced composites, pre-impregnated fiber (pre-peg) autoclave curing for high-performance composites, pressure forming techniques such as compression molding, vacuum forming for thermoplastic shaping, and other advanced manufacturing processes suitable for the specific material and performance requirements of the battery thermal management system.

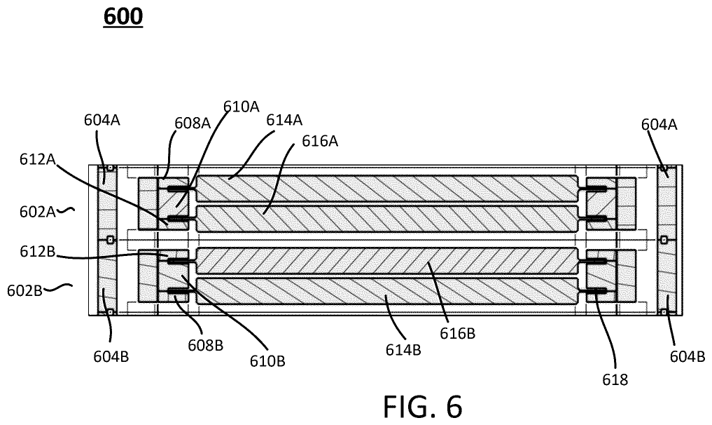

FIG. 6 illustrates multiple frames of a battery cooling system securing a set of batteries. As shown in FIG. 6, the battery cooling system 600 can include a first frame 602A and a second frame 602B. The first frame 602A can secure a first battery 614A and a second battery 616A, while second frame 602B can similarly secure a first battery 614B and a second battery 616B.

The frames 602A-B can include an outer subframe 604A, 604B. Outer frames 604A-B can encapsulate elements in each respective frame 602A-B. For instance, the first frame 602A can have an outer subframe 604A that encapsulates inner subframes 608A, 610A, 612A and batteries 614A, 616A, and second frame 602B can have an outer subframe 604B that encapsulates inner subframes 608B, 610B, 612B and batteries 614B, 616B.

The first frame 602A can include a first inner subframe 610A disposed within the outer subframe 604A. The first inner subframe 610A can be configured to be disposed at a first side of a first battery cell 614A and a second battery cell 616A. Further, a second inner subframe 608A can be disposed at a second side of the first battery cell 614A. The first inner subframe 610A and the second inner subframe 608A can secure the first battery cell. A third inner subframe 612A can be disposed at a second side of the second battery cell 616A. The first inner subframe 610A and the third inner subframe 612A can secure the second battery cell 616A.

Further, as shown in FIG. 6, the battery cells (e.g., 614A-B, 616A-B) can include an excess portion 618. As described in greater detail below, part of the frames can clamp to the excess portion of the battery cells (e.g., excess portion 618 of battery cell 614B).

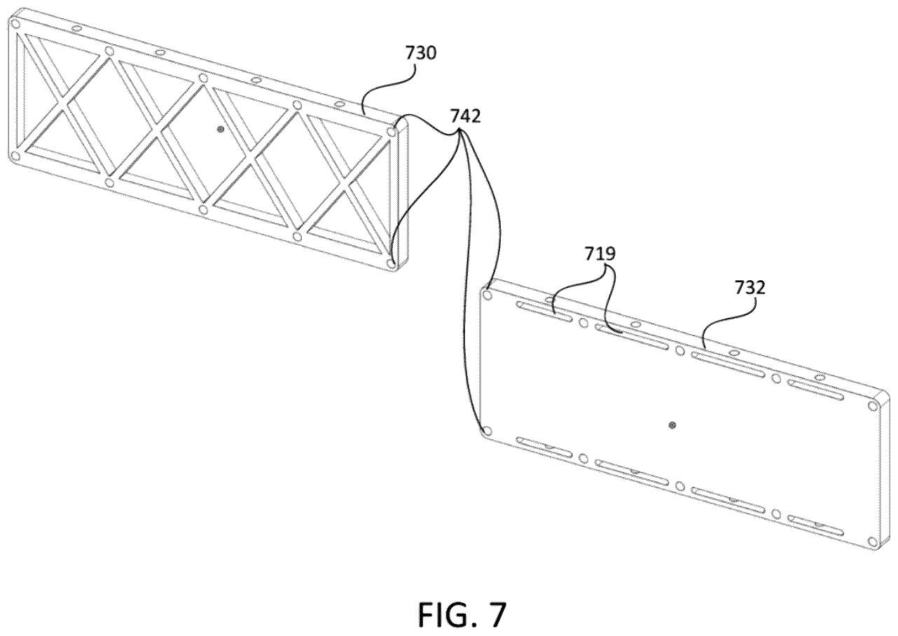

FIG. 7 illustrates a front plate 730 and an end plate 732 as described herein. These plates can form the two ends of the stacks or sandwiches and keep the pressure within the system.

The front plate 730 and end plate 732 may provide the compression force necessary to maintain the frames in proper contact, ensuring adequate sealing and mechanical alignment throughout the assembly. The front plate 730 and end plate 732 include tension rod guides 742 positioned to receive and locate the tension rods that secure the module assembly together in a unified structural configuration.

The front plate 730 and end plate 732 further comprise coolant manifolds 719 to facilitate uniform distribution of liquid coolant across the plurality of carrier plates within the system. The coolant manifolds 719 can be dimensioned and positioned to improve flow characteristics and pressure distribution throughout the cooling circuit. Additionally, coolant inlet and outlet ports can be integrated into the front plate 730 and end plate 732 to direct the flow of coolant into and out of the system, thereby establishing a controlled thermal management pathway for the battery assembly.

The front plate 730 and end plate 732 may be manufactured with various materials including metals such as aluminum, steel, titanium, or magnesium alloys, thermoplastics such as polyethylene, polypropylene, or polycarbonate, polymers including epoxy resins, polyurethane or polyamide, and composite materials such as carbon fiber reinforced plastics, glass fiber composites, or hybrid fiber composites. These components may be produced using different manufacturing methodologies including casting processes such as sand casting or investment casting, pressure casting techniques, die casting for high-volume production, injection molding for thermoplastic components, additive manufacturing processes such as 3D printing including selective laser sintering or fused deposition modeling, computer numerical control (CNC) machining for precision components, vacuum infusion for composite materials, wet layup processes for fiber-reinforced composites, pre-impregnated fiber (pre-peg) autoclave curing for high-performance composites, pressure forming techniques such as compression molding, vacuum forming for thermoplastic shaping, and other advanced manufacturing processes suitable for the specific material and performance requirements of the battery thermal management system.

### Electrical Connection Examples

As described herein, a wet busbar system on and in the module can include an inner busbar (not shown) which includes an electrical connection to the battery cell and an outer busbar in electrical connection to the inner busbar. In such a way, the inner busbar may remain in the module wet and in contact with the battery cell along with any liquid coolant within the modules and manifolds but keep the liquid inside the system.

The inner wet busbar may be designed to operate safely in the presence of dielectric coolant fluid, allowing direct electrical contact with the battery cell terminals while being immersed in or exposed to the pressurized liquid coolant environment. This wet busbar may be constructed from corrosion-resistant conductive materials such as copper, aluminum, or specialized alloys that may withstand prolonged exposure to the coolant chemistry without degradation. The electrical connection to the inner wet busbar with the outer busbar may be achieved through a sealed feedthrough mechanism that maintains electrical continuity while preventing coolant leakage. This feedthrough may incorporate specialized sealing technologies such as hermetic seals, O-ring assemblies, or gasket systems that may withstand the operating pressures of 1-10 bars while maintaining electrical isolation between the wet and dry environments.

The outer busbar provides a clean, accessible electrical interface that may allow the electrical connection to any load outside the cells, outside the modules, and to any overall system to be powered such as an electric vehicle or other electrical motor, etc. The outer busbar may include standard electrical connection features such as threaded terminals, quick-disconnect connectors, or other industry-standard interfaces to facilitate integration with external power management systems, inverters, or load circuits.

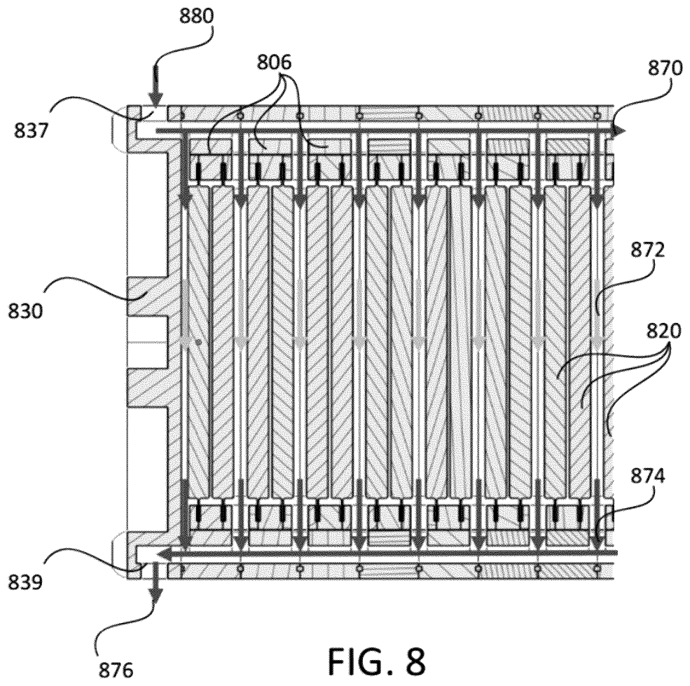

FIG. 8 illustrates an example configuration of a plurality of frames arranged within a thermal management system configuration, wherein the diagram demonstrates the controlled flow pathways and circulation patterns of liquid coolant throughout the battery cooling system. In accordance with the thermal management methodology described herein, cold and pressurized liquid coolant is introduced at the superior portion of the system assembly through predetermined inlet configurations, wherein said coolant is directed to flow through a network of interconnected channels, manifold passages, and inter-cellular cooling pathways positioned between adjacent battery cells to facilitate thermal energy capture and heat removal from the electrochemical energy storage system.

As depicted in the flow diagram indicated by directional arrow 880, pressurized cold coolant may enter the system through the front plate 830 via entrance port 837 and subsequently flows across frames (e.g., 806) through the coolant manifold channel 870. At predetermined intervals between adjacent battery cells 820, the coolant may be directed to flow downward through the inter-cell channel 872, thereby facilitating thermal energy removal from the electrochemical cells. In some examples, the inter-cell cooling channels may have width dimension of approximately 5 millimeters (mm). In alternative embodiments, the channel width may be within a range of approximately 2 mm to 8 mm, depending upon specific thermal management requirements and system design parameters. An additional coolant manifold positioned on the exit side 874 of the module assemblies may facilitate coolant flow past the battery cells 820 and direct the heated coolant toward the exhaust collection system. Upon completion of the thermal exchange process, the heated coolant is collected on exit side 874 of the module assemblies and subsequently exhausted through outlet pathway 876 via the end plate 830 at the designated exit port 839.

The modular system architecture may enable the arrangement of any predetermined number of module assemblies in accordance with the configuration illustrated in FIG. 8, wherein the thermal management system may be replicated and scaled according to specific application requirements. In some examples, an additional end plate assembly, substantially similar in design configuration to front plate, may be incorporated to facilitate coolant recirculation at predetermined carrier plate intervals, thereby minimizing temperature gradients throughout the battery assembly and maintaining uniform thermal conditions across the electrochemical energy storage system.

The pressure characteristics of the liquid coolant within the system and between adjacent battery cells may be regulated through the utilization of a pressurization pump assembly (not depicted in the figure) which may force coolant into the entrance port 837 at predetermined pressure levels. The predetermined pressure parameters may be dependent upon specific battery cell characteristics and operational requirements, with exemplary pressure ranges typically maintained between approximately 1 bar and 4 bars of pressure. In certain high-performance applications, pressure levels may be maintained at elevated levels up to approximately 80 bars, representing the upper operational limit for the pressure containment system. In various embodiments, a burp tank assembly or alternative reservoir system may be incorporated to provide pressure regulation and accommodate thermal expansion effects within the cooling circuit.

The modular construction methodology may enable improved energy density per kilogram while maintaining the original energy capacity of the individual cells. The thermal and pressure management system may maintain the battery cells in a isobaric operational state with consistent pressure distribution applied uniformly around the cell periphery. This uniform pressure distribution facilitates better battery performance and operational efficiency. Additionally, the uniform pressure distribution around each cell periphery provides enhanced protection against delamination effects that may compromise cell integrity and performance characteristics.

### Passive Choke Valve Examples

To achieve and maintain substantially homogeneous thermal distribution characteristics between individual electrochemical cells positioned within different carrier plate assemblies throughout the modular battery thermal management system, a thermally actuated choke mechanism or passive flow control device may be strategically incorporated within the coolant circulation pathways to provide autonomous thermal regulation capabilities.

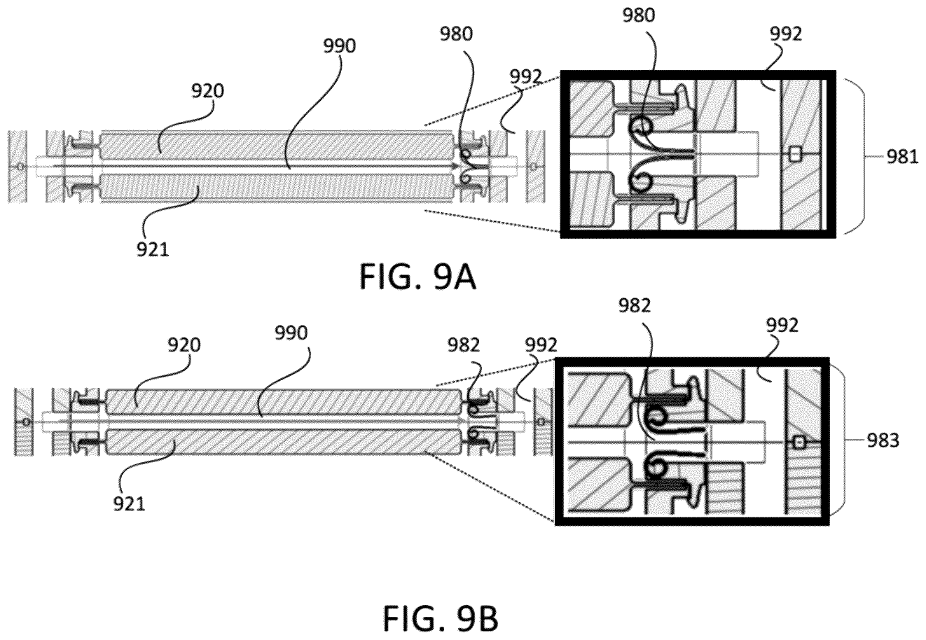

FIGS. 9A and 9B illustrate detailed sectional views of two adjacent electrochemical cells 920 and 921, and the intermediate coolant channel 990 positioned between them within the modular assembly configuration. To reduce (e.g., minimize) thermal gradients across the battery assembly and provide compensation for the thermal expansion or contraction characteristics of the coolant channels 990 during operational temperature variations, a passive flow control device or thermally actuated choke valves 980 and 982 may be positioned at the end of the coolant channels 990 close to a upstream of an outlet manifold 992, thereby providing autonomous flow regulation capabilities responsive to thermal and pressure conditions within the cooling circuit. The flow control device may include a thermally responsive valve assembly to autonomously open and close in direct response to temperature variations of the liquid coolant medium without requiring external control signals or power input.

FIG. 9A illustrates a detailed configuration with the choke valve 980 in the closed operational state and provides an enlarged detail view of the same valve mechanism 981. In such exemplary configurations, the choke valve 980 in the closed position substantially restricts or prevents the movement of liquid coolant at the designated position within the cooling system as shown in proximity to the outlet manifold 992. When the coolant medium exhibits relatively low temperature characteristics, valve 980 assumes a partially closed configuration, thereby allowing the electrochemical cells to achieve their operating temperature more rapidly by reducing heat extraction rates during the initial thermal conditioning phase.

FIG. 9B illustrates a detailed configuration with the thermally actuated valve 982 in the open operational state and provides an enlarged detail view of the same valve mechanism 983, thereby facilitating unrestricted movement of liquid coolant through the valve assembly. When the system coolant medium reaches the predetermined operating temperature threshold, the choke valve 982 transitions to the open configuration, thereby allowing increased coolant flow rates and consequently enhancing heat removal capacity from the electrochemical cells 920 and 921 to maintain the predetermined thermal operating conditions.

Similarly, when the intermediate channel 990 positioned between adjacent cells 920 and 921 undergoes dimensional contraction due to thermal expansion of the electrochemical cells during operational heating cycles, the flow control check valve 982 responds autonomously to the corresponding increase in hydraulic pressure within the cooling circuit, opening to a greater degree to accommodate additional coolant flow volume and maintain pressure characteristics throughout the thermal management system.

In some instances, the electrical connection assemblies for the modular battery system comprise an inner busbar access interface to provide electrical continuity between the wet and dry environments of the system. This dual-environment electrical connection system may be designed to function both on the wet, internal side where the system is flooded with dielectric coolant medium and through the external module assemblies, thereby enabling electrical energy extraction while maintaining coolant containment integrity.

### Pressure Examples

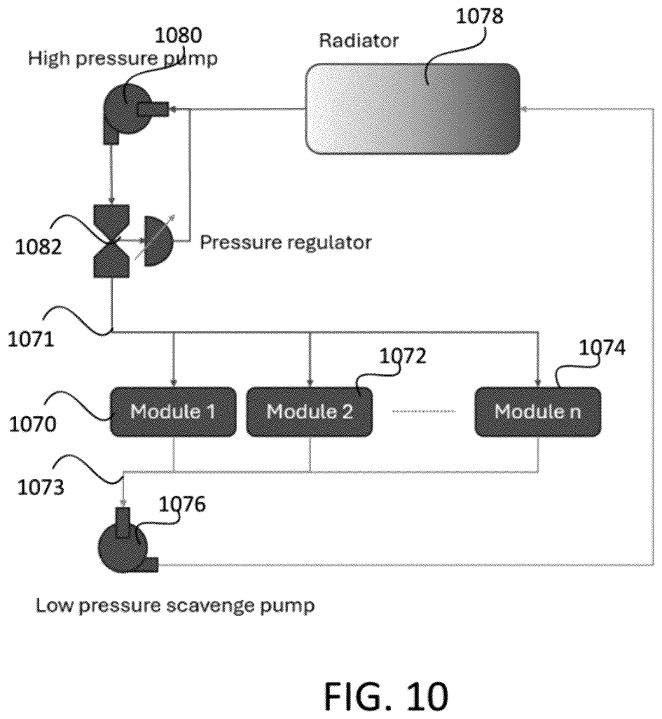

FIG. 10 illustrates a schematic diagram depicting the integrated coolant circulation and pressurization system architecture to provide thermal and pressure management throughout the modular battery thermal management system. The battery modules 1070, 1072, 1074 incorporated within the system assembly may demonstrate a better electrochemical performance characteristic within predetermined temperature ranges, thereby necessitating precise thermal regulation capabilities as described herein. To achieve and maintain the predetermined operating temperatures within the battery system assembly, the cold coolant medium 1071 to flow between and around the battery modules 1070, 1072, 1074 to facilitate thermal energy removal and heat dissipation, may be simultaneously utilized to provide controlled pressurization of the electrochemical cells contained within the modules.

A high-pressure pump assembly 1080 and a low-pressure pump assembly 1076 may be operatively arranged within the coolant circulation system in conjunction with a pressure regulator 1082 that are strategically installed and integrated within the overall cooling system architecture. Cold coolant medium 1071 emanating from the radiator heat exchanger 1078 is pressurized by the high-pressure pump assembly 1080 and subsequently directed through the coolant distribution network to the battery modules 1070, 1072, 1074 via the pressure regulator 1082. The pressure regulator 1082 may ensure that predetermined target pressure levels are achieved and maintained at the battery modules 1070, 1072, 1074, thereby providing optimal pressure conditions for enhanced electrochemical performance and structural integrity of the battery cells contained within the modular assemblies.

Heated lower pressure coolant medium 1073, having absorbed thermal energy from the battery modules during the heat exchange process, may be collected and directed by the low-pressure pump assembly 1076 and subsequently pumped to the radiator heat exchanger 1078 to facilitate thermal energy dissipation and coolant temperature reduction. Upon completion of the cooling process within the radiator heat exchanger 1078, the high-pressure pump assembly 1080 may initiate the subsequent circulation cycle by directing the cooled coolant medium 1071 to the pressure regulator 1082 and subsequently to the battery modules 1070, 1072, 1074, where the thermal management cycle continues in accordance with the operational parameters and methodologies described herein.

In such a configuration, the integrated thermal management system may provide controlled liquid coolant pressure regulation and temperature modulation to circulate around and between the battery cells positioned within the modular system assembly. The system may optimize electrochemical performance characteristics, enhance operational efficiency, and maintain the predetermined battery cell operating conditions throughout the operational envelope of the battery thermal management system.

### Example Embodiments

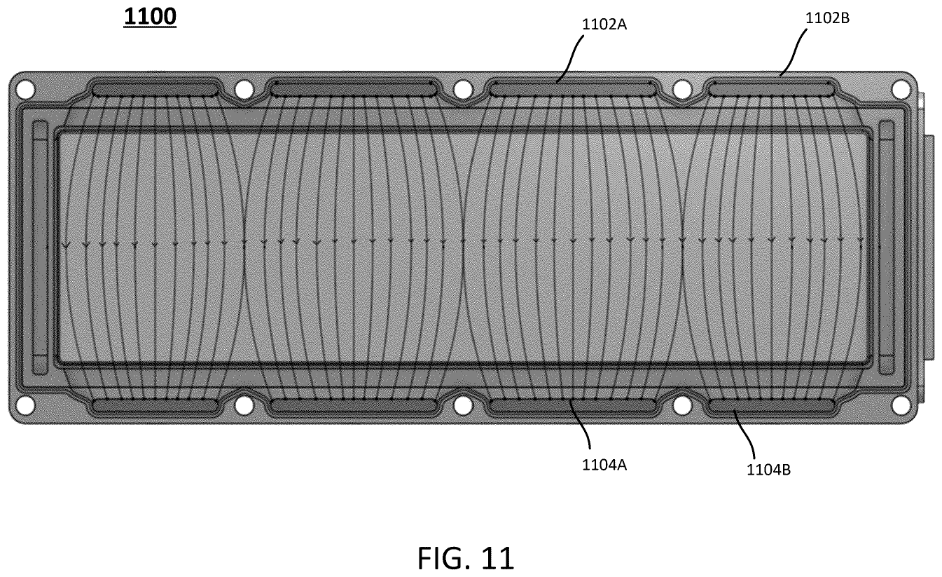

In some instances, the outer subframe of any example frame can include coolant channels configured to flow through any side of the outer subframe. FIG. 11 illustrates an example outer subframe 1100. As shown in FIG. 11, the outer subframe 1100 can include inlets 1102A, 1102B and outlets 1104A, 1104B. A coolant can flow through any of a number of channels formed between inlets 1102A-B and outlets 1104A-B. In some examples, the outer subframe can connect to the end plates such that coolant can flow between the end plates and the outer subframe.

The outer subframe 1100 can include a coolant diffuser between cooling channels on a side of the outer subframe 1100. The coolant diffuser can improve control of the coolant flow to make sure it is channeled in properly through the intended slots and to manage any local pressure issues in the frame.

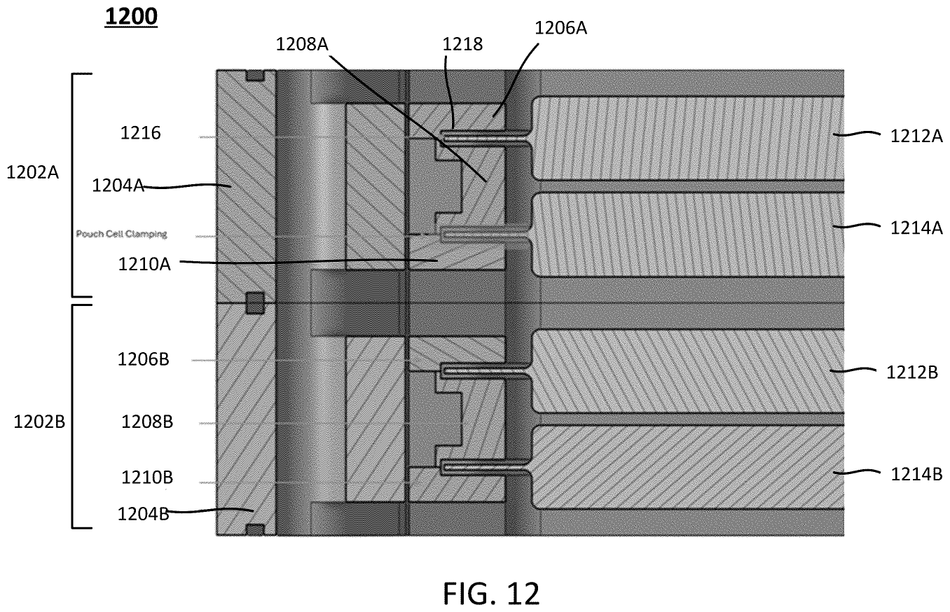

FIG. 12 illustrates example frames 1202A, 1202B as part of a battery cooling system 1200. As shown in FIG. 12, each frame 1202A-B can include battery cells 1212A, 1212B, 1214A, 1212B disposed between subframes 1204A, 1204B, 1206A, 1206B, 1208A, 1208B, 1210A, 1210B. For instance, a first frame 1202A can include an outer subframe 1204A encapsulating a first inner subframe 1208A, a second inner subframe 1206A, and a third inner subframe 1210A.

Each battery cell 1212A-B, 1214A-B can include an excess portion 1216 at any end of the battery cell. For instance, cell 1212A can have excess portion 1216 that is disposed in a recess 1218 formed between any of the first inner subframe 1208A and the second inner subframe 1206A. The recess 1218 can providing a clamping force onto the battery cells (e.g., 1212A) to secure the battery cell in place.

The clamping mechanism may provide several operational advantages for the battery cooling system as described herein. For instance, the subframes may serve as compression elements that maintain the battery cells 504 and 510 in predetermined positions while accommodating thermal expansion during operational cycles. The subframes can also facilitate heat transfer and thermal equalization between adjacent cells within the frame. In some cases, this configuration may enable the coolant manifold channels to provide thermal management for both battery cells simultaneously through a single coolant circulation pathway. The clamping arrangement may also provide mechanical protection for the battery cells during assembly, transportation, and operational vibration conditions, while maintaining the electrical isolation and thermal management characteristics for better system performance.

In some instances, the subframes described herein can include slots that can reduce the mass on the clamping mechanism of the cell and allow coolant to flow on the longer side of the subframes.

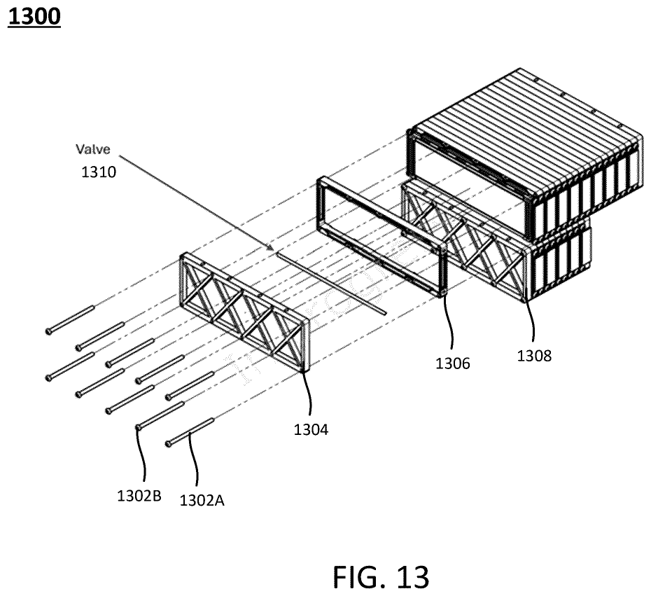

FIG. 13 illustrates an example exploded view of the battery cooling system as described herein. As shown in FIG. 13, system 1300 can include a first end plate 1304, a frame 1306, and a second end plate 1308. The end plates 1304, 1308, and frame 1306 can be secured via fasteners 1302A, 1302B securing each element. Further, a valve 1310 can be formed between any end plate (e.g., 1304, 1308) and the frame. The valve can control a flow of the coolant between the elements in the battery cooling system.

The active choke or flow control device can expand or contract the outlet of the channel of any based on coolant temperature to provide homogenous flow and regulate the amount of pressure to each adjacent subframes. The active choke or flow control device may be thermally actuated and may respond automatically to temperature changes in the coolant without requiring external control signals.

In some aspects, the active choke or flow control device may include a thermally responsive element that changes shape or position as the coolant temperature varies, thereby modulating the flow cross-sectional area of the channel outlet. The active choke or flow control device may assist to maintain uniform temperature distribution across multiple modules by restricting flow when coolant is cooler and allowing increased flow when coolant temperature rises. In some cases, the device may also respond to pressure changes within the channel, opening further when pressure increases due to thermal expansion of the coolant or battery cells. This dual responsiveness to both temperature and pressure may provide enhanced control over the thermal management system. The choke device may be positioned at various locations along the coolant flow path, including at channel exits, manifold junctions, or intermediate points within the cooling circuit.

In one aspect, the present disclosure relates to a battery cooling system comprising a first end plate comprising an inlet and an outlet, a plurality of modules connected to the inlet and the outlet of the first end plate, wherein each of the plurality of modules comprising a set of internal coolant manifolds and are to house any of a plurality of battery cells, a plurality of inner wet bus electrical connections each disposed on an inside of the plurality of modules and to be in communication with the plurality of battery cells, a plurality of outer dry bus electrical connections in electrical communication with the plurality of inner wet bus electrical connections and configured to conduct electrical current from the plurality of battery cells to an external circuit outside the plurality of modules, a second end plate disposed adjacent to the plurality of modules, and a security system securing the first end plate and the second end plate to the plurality of modules, wherein a liquid coolant is configured to move between the inlet of the first end plate, the set of internal coolant manifolds of any of the plurality of modules, and through the outlet of the first end plate.

In embodiments of this aspect, the disclosure according to any one of the above example embodiments, any of the plurality of modules further includes an inner carrier plate and an outer carrier plate configured to be disposed around a first battery cell of the plurality of battery cells.

In embodiments of this aspect, the disclosure according to any one of the above example embodiments, the inner carrier plate and the outer carrier plate comprise any of a metal, a thermoplastic, a polymer, and a composite material.

In embodiments of this aspect, the disclosure according to any one of the above example embodiments, the plurality of battery cell is at least one of a Lithium-ion battery cell, a Lithium-Iron-Polonium battery cell, a Lithium-Silicon battery, a Lithium-Metal battery, and a Solid-State battery.

In embodiments of this aspect, the disclosure according to any one of the above example embodiments, further comprising a pump and a reservoir connected to the set of coolant manifolds of any of the plurality of modules to regulate a pressure of the liquid coolant disposed in the battery cooling system.

In embodiments of this aspect, the disclosure according to any one of the above example embodiments, the pump maintains the liquid coolant at a pressure between 1 bar and 10 bars within the set of coolant manifolds of the plurality of modules.

In embodiments of this aspect, the disclosure according to any one of the above example embodiments, the securing system comprises a set of bolts extending through the first end plate, through each the plurality of modules, and threaded into the second end plate.

In embodiments of this aspect, the disclosure according to any one of the above example embodiments, the first end plate, the plurality of modules, and the second end plate form a load bearing structural unit when secured together by the securing system.

In embodiments of this aspect, the disclosure according to any one of the above example embodiments, further comprising a first liquid seal disposed between the first end plate and a first module of the plurality of modules, and a second liquid seal disposed between the second end plate and a second module of the plurality of modules.

In embodiments of this aspect, the disclosure according to any one of the above example embodiments, further comprising one or more thermally operated choke valves disposed within any of the set of internal coolant manifolds, wherein the one or more thermally operated choke valves are configured to open and close based on thermal conditions of the liquid coolant.

In one aspect, the present disclosure relates to a method of cooling a battery system comprising providing a first end plate having an inlet and an outlet, disposing a plurality of modules adjacent to the first end plate, wherein each of the plurality of modules comprising a set of internal coolant manifolds in communication with the inlet and the outlet of the first end plate, wherein each module is configured to house any of a plurality of battery cells, disposing a plurality of inner wet bus electrical connections on each of the plurality of modules such that the inner wet bus electrical connections are in electrical communication with the plurality of battery cells, connecting a plurality of outer dry bus electrical connections to the plurality of inner wet bus electrical connections, wherein the plurality of outer dry bus electrical connections are configured to conduct an electrical current from the plurality of battery cells to an external circuit disposed exterior to the plurality of modules, providing a second end plate adjacent to the plurality of modules, and securing the first end plate and the second end plate to the plurality of modules.

In embodiments of this aspect, the disclosure according to any one of the above example embodiments, further comprising disposing a liquid coolant into the inlet of the first end plate, through the coolant manifolds of the plurality of modules, and through the outlet of the first end plate.

In embodiments of this aspect, the disclosure according to any one of the above example embodiments, each of the plurality of modules further include an inner carrier plate and an outer carrier plate disposed between a first battery cell of the plurality of battery cells.

In embodiments of this aspect, the disclosure according to any one of the above example embodiments, the inner carrier plate and the outer carrier plate include a material selected from the group consisting of: metals, thermoplastics, polymers, and composite materials.

In embodiments of this aspect, the disclosure according to any one of the above example embodiments, the plurality of battery cell is at least one of a Lithium-ion battery cell, a Lithium-Iron-Polonium battery cell, a Lithium-Silicon battery, a Lithium-Metal battery, and a Solid-State battery.

In embodiments of this aspect, the disclosure according to any one of the above example embodiments, further comprising providing a pump and a reservoir in communication with the coolant manifolds of the plurality of modules to regulate pressure of the liquid coolant inside the battery cooling system.

In embodiments of this aspect, the disclosure according to any one of the above example embodiments, the pump is configured to maintain the liquid coolant at a pressure between 1 bar and 10 bars within the coolant manifolds of the plurality of modules.

In embodiments of this aspect, the disclosure according to any one of the above example embodiments, the security system comprises bolts to extend through the first end plate, through the plurality of modules, and thread into the second end plate.

In embodiments of this aspect, the disclosure according to any one of the above example embodiments, further comprising disposing a first liquid seal between the first end plate and an adjacent module of the plurality of modules, and disposing a second liquid seal between the second end plate and an adjacent module of the plurality of modules.

In embodiments of this aspect, the disclosure according to any one of the above example embodiments, further comprising disposing a set of thermally operated choke valves within the set of internal coolant manifolds, wherein the thermally operated choke valves open and close based on thermal conditions of the liquid coolant.

### Conclusion

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and their practical applications, to thereby enable others skilled in the art to best utilize the various embodiments with various modifications as are suited to the particular use contemplated.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the embodiments have been specifically described herein, it will be apparent to those skilled in the art to which the embodiments pertain that variations and modifications of the various implementations shown and described herein may be made without departing from the spirit and scope of the embodiments. Accordingly, it is intended that the embodiments be limited only to the extent required by the applicable rules of law.

What is claimed is:

1. A battery cooling system comprising:
a first end plate that includes:
a first inlet port for receiving a liquid coolant;
a first outlet port; and
at least a first manifold channel formed in the first end plate and configured to carry the liquid coolant along the first end plate between the first inlet port and the first outlet port;
a first frame disposed adjacent to the first end plate, the first frame comprising:
an outer subframe;
a first inner subframe disposed within the outer subframe, wherein the first inner subframe is configured to be disposed at a first side of a first battery cell and a second battery cell;
a second inner subframe disposed at a second side of the first battery cell, wherein the first inner subframe and the second inner subframe secure the first battery cell;
a third inner subframe disposed at a second side of the second battery cell, wherein the first inner subframe and the third inner subframe secure the second battery cell;
a wet bus disposed in an interior of the outer subframe and configured to be electrically connected to any of the first battery cell and the second battery cell; and
a dry bus disposed on an exterior of the outer subframe and electrically connected to the wet bus; and
a second end plate disposed adjacent to the first frame at an opposite side as the first end plate, wherein the second end plate comprises:
a second inlet port;
a second outlet port; and
at least a second manifold channel formed in the second end plate and configured to carry the liquid coolant between the second inlet port and the second outlet port along the second end plate.

2. The battery cooling system of claim 1, wherein the first inner subframe, the second inner subframe, and the third inner subframe are encapsulated by the outer subframe.

3. The battery cooling system of claim 1, further comprising:
a set of fasteners disposed between the first end plate, the first frame, and the second end plate to secure the first end plate to the second end plate.

4. The battery cooling system of claim 1, wherein the second inner subframe comprises a recess configured to clamp an excess portion of the first battery cell extending from the first battery cell.

5. The battery cooling system of claim 1, wherein the outer subframe further comprises a number of channels disposed on at least one side of the outer subframe and connected to any of the first manifold channel and the second manifold channel, wherein the number of channels are configured to control a flow of the liquid coolant through the number of channels.

6. The battery cooling system of claim 5, wherein a choke is disposed between any of the number of channels in the outer subframe, wherein the choke is configured to increase or reduce the flow the liquid coolant through the number of channels based on temperature of the liquid coolant.

7. The battery cooling system of claim 1, further comprising:
a second frame disposed between the first frame and the second end plate, wherein the second frame is configured to retain a third battery cell and a fourth battery cell.

8. The battery cooling system of claim 7, wherein the first battery cell, the second battery cell, the third battery cell, and the fourth battery cell include any of a Lithium-ion battery cell, a Lithium-Iron-Polonium battery cell, a Lithium-Silicon battery, a Lithium-Metal battery, and a Solid-State battery.

9. The battery cooling system of claim 1, further comprising:
a pump and a reservoir connected to any of the first manifold channel or the second manifold channel to regulate a pressure of the liquid coolant disposed in the battery cooling system.

10. The battery cooling system of claim 9, wherein the pump maintains the liquid coolant at a pressure between 1 bar and 10 bars.

11. The battery cooling system of claim 1, wherein the first end plate, the first frame, and the second end plate form a load bearing structural unit when secured together.

12. The battery cooling system of claim 1, further comprising:
a first liquid seal disposed between the first end plate and the second inner subframe of the first frame; and
a second liquid seal disposed between the second end plate and the third inner subframe of the first frame.

13. A method for manufacturing a battery cooling system, the method comprising:
providing a first end plate that includes:
a first inlet port;
a first outlet port; and
at least a first manifold channel formed in the first end plate;
disposing a first frame adjacent to the first end plate, the first frame comprising:
an outer subframe;
a number of inner subframes encapsulated within the outer subframe and configured to retain at least a first battery cell and a second battery cell;
a wet bus disposed in an interior of the outer subframe and configured to be electrically connected to any of the first battery cell and the second battery cell; and
a dry bus disposed on an exterior of the outer subframe and electrically connected to the wet bus; and
disposing a second end plate adjacent to the first frame at an opposite side as the first end plate, wherein the second end plate comprises:
a second inlet port;
a second outlet port; and
at least a second manifold channel formed in the second end plate.

14. The method of claim 13, wherein the number of inner subframes includes:
a first inner subframe disposed within the outer subframe, wherein the first inner subframe is configured to be disposed at a first side of the first battery cell and the second battery cell;
a second inner subframe disposed at a second side of the first battery cell, wherein the first inner subframe and the second inner subframe secure the first battery cell; and
a third inner subframe disposed at a second side of the second battery cell, wherein the first inner subframe and the third inner subframe secure the second battery cell.

15. The method of claim 13, further comprising:
receiving a coolant at any of the first inlet port and the second inlet port, wherein the coolant is configured to traverse from the first inlet port and/or the second inlet port to the first outlet port and/or the second outlet port via the first manifold channel and/or the second manifold channel.

16. The method of claim 13, further comprising:
securing a set of fasteners between the first end plate, the first frame, and the second end plate to secure the first end plate to the second end plate.

17. The method of claim 15, further comprising:
disposing a choke between any of a number of channels formed in the outer subframe, wherein the choke is configured to increase or reduce a flow of the coolant through the number of channels based on temperature of the coolant.

18. The method of claim 13, further comprising:
disposing a second frame between the first frame and the second end plate, wherein the second frame is configured to retain a third battery cell and a fourth battery cell.

19. The method of claim 15, further comprising:
connecting a pump and a reservoir to any of the first manifold channel or the second manifold channel to regulate a pressure of the coolant disposed in the battery cooling system.

20. The method of claim 14, further comprising:
disposing a first liquid seal between the first end plate and the second inner subframe of the first frame; and
disposing a second liquid seal between the second end plate and the third inner subframe of the first frame.
